(19) United States
(12) Patent Application Publication
(10) Pub. No.: US 2011/0127699 A1
(43) Pub. Date: Jun. 2, 2011

(54) Method And Apparatus For Thermally Debindering A Cellular Ceramic Green Body

(76) Inventors: Michael James Vayansky, Elkland, PA (US); Douglas Richard Wing, Painted Post, NY (US)

(21) Appl. No.: 12/627,000

(22) Filed: Nov. 30, 2009

(51) Int. Cl. C04B 33/32; F27D 5/00

(52) U.S. Cl. 264/630; 432/258

(57) ABSTRACT

Cellular ceramic green bodies are debindered in a heated circulating oxygen-containing atmosphere while being supported on a plurality of flow-restricting support members for selectively restricting circulation of the atmosphere through cellular core sections of the bodies, and while allowing for a free circulation of the atmosphere past the support members and green bodies.

### BACKGROUND

The methods and apparatus disclosed herein relate generally to the manufacture of ceramic honeycombs, and more particularly to the heating of cellular ceramic green bodies to remove binding constituents therefrom prior to firing to reaction sinter the green bodies to ceramic honeycombs.

Ceramic honeycombs composed of refractory ceramic materials such as cordierite, silicon carbide, aluminum titanate and the like are widely used for the manufacture of catalytic substrates and particulate filters. Such substrates and filters are presently needed for the removal of pollutants such as carbon monoxide, nitrogen and sulfur oxides, unburned hydrocarbons and particulates such as soot from combustion engine exhaust gases or stack gases from industrial combustion processes.

The firing of cellular ceramic green bodies to convert them to ceramic honeycombs first requires the debindering or removal from the bodies of various organic binding or pore-forming constituents. Those constituents are required in the earlier forming stage of manufacture for the shaping of plastic mixtures of ceramic precursor powders and binding constituents into self-supporting green cellular shapes. Shaping is typically by extrusion of the plastic mixtures through honeycomb extrusion dies.

Significant manufacturing difficulties can arise where the green honeycomb shapes comprise more than about 5% by weight of organic constituents such as cellulosic binders and/or pore forming additives such as starch that are combustible. High rates of cracking can be observed in the fired ware if the removal of organic binding and/or pore-forming constituents is not carefully managed. The debindering of large cellular green bodies, such as those used for the production of cordierite particulate filters or combustors for treating heavy duty diesel engine exhaust streams is particularly problematic.

The predominant source of cracking during the debindering of cellular ceramic green bodies is thought to be an uncontrolled burning (thermal runaway) of the organics within the cores of the cellular green ware. Such burning generates large thermal gradients in the green ware that in turn produce thermal stresses great enough to cause cracking during debindering.

A number of approaches to address such cracking have been proposed. These include the use of low oxygen debindering atmospheres to reduce organics combustion rates, the use of reduced heating rates during debindering to reduce internal temperature differentials within the bodies, and the use of increasing levels of gas circulation through the cells of the bodies during debindering in order to improve temperature uniformity within the bodies. Nevertheless, significant levels of cracking in fired ceramic honeycombs are still encountered.

### SUMMARY

In accordance with embodiments of the methods disclosed herein, the debindering of a cellular ceramic green body comprises a step of heating the green body in a circulating atmosphere of heated oxygen-containing gases while selectively restricting circulation of the gases through the cellular core section of the body. In some embodiments, selectively restricting circulation of the atmosphere through the cellular core section of the body comprises heating the green body while supporting the green body on a flow restricting horizontal support surface. The horizontal support surface has an area at least sufficient to block circulating gas flow through at least a majority of the cells of the green body positioned on the support surface, but insufficient materially restrict the circulation of the gases over the lateral or circumferential side surfaces of the green body.

The present disclosure further comprises apparatus for debindering cellular ceramic green bodies. Embodiments of that apparatus comprise a kiln having a heating enclosure for heating the bodies, together with base supports disposed within the heating enclosure that include spacings allowing for a free circulation of heated oxygen-containing gases past the base supports. Those embodiments further comprise a plurality of flow restricting green body support members disposed on the base supports for restricting the passage of heated oxygen-containing gases through cellular core portions of green bodies while the bodies are situated on the support members.

The apparatus further comprises kiln inlets for admitting heated oxygen-containing gases into the heating enclosure; and gas circulation means for circulating the heated oxygen-containing gases past the base supports, green body support members, and green bodies situated on the green body support members. In selected embodiments, the green body support members comprise disc supports incorporating horizontal support surfaces. Each of the support surfaces has an area at least sufficient to block heated gas flow through a majority of the cells of a green body supported with cell openings facing the support surface. However the support surface area is insufficient to materially restrict the circulation of heated oxygen-containing gases past the lateral surfaces of the supported green body.

### BRIEF DESCRIPTION OF THE DRAWINGS

Embodiments of the methods and apparatus disclosed above are further described below with reference to the appended drawings, wherein:

FIG. 1 is a graph plotting green body core temperatures against kiln temperature during debindering;

FIG. 2 illustrates apparatus suitable for the practice of the disclosed methods;

FIG. 3 presents a detailed view of a portion of the apparatus;

FIG. 4 presents a further detailed view of a portion of the apparatus; and

FIGS. 5a and 5b illustrate an embodiment of a green body support member.

### DETAILED DESCRIPTION

The methods and apparatus of the present disclosure have particular application to the debindering of large cellular ceramic green bodies of the kind produced for the fabrication of honeycomb catalyst supports or filters for heavy duty diesel or gasoline combustion engines. A significant share of such honeycomb production consists of refractory, low-expansion cordierite (magnesium aluminosilicate) honeycombs that are formed by the reaction-sintering of plasticized mixtures of clay, talc, alumina and other precursor powders combined with binders such as cellulose ethers and pore formers such as starch or graphite. Embodiments of the methods and apparatus of the present disclosure may therefore be described below with reference to the debindering of such cordierite cellular green bodies even though the use of such methods and apparatus is not limited thereto.

The present methods and apparatus are particularly well suited for the removal of relatively high levels of organics from cordierite honeycomb bodies. Among the processing variables impacting the effectiveness of the disclosed methods for cordierite honeycomb debindering are the ware setter type, the oxygen levels maintained in the kiln, the heating rates employed during debindering, and the kiln atmosphere flow rates used for the circulation of heated oxygen-containing gases over ware being subjected to debindering.

The use of solid refractory discs as green body support members, replacing supports such as ring setters of the kind used in the prior art to promote gas circulation through the cellular interiors of the green bodies, significantly reduces thermal gradients within the green cellular ceramic bodies being processed. Such discs effectively limit the amount of oxygen accessing the cores of the green bodies, limiting the possibility of an uncontrolled burning of the organics in the ware core. The disc supports to be selected, however, should have diameters similar to the diameters of the ware to be debindered, in order to assure substantially unrestricted access to the outer surfaces of the ware by the circulating oxygen-containing gases.

The effectiveness of embodiments of the disclosed methods and apparatus employing solid disc setters as support members for the debindering of cellular green bodies is illustrated in FIG. 1 of the appended drawings. FIG. 1 plots typical mid-core temperatures that can be measured within the central cores of large green cellular cordierite bodies during the slow heating of a kiln to a temperature sufficient to achieve the complete removal of organics from the bodies. The temperatures within the kiln during that heating are shown by plot K in the figure.

The plot labeled “P” in FIG. 1 reports core temperatures representative of those measured during the heating of a large green cordierite cellular body supported on a ring setter of a design employed in the prior art. The configuration of such ring setters is substantially that disclosed, for example, in published U.S. Patent Application US 2008/0116621. The plot labeled “I” in FIG. 1 reports core temperatures representative of those measured during heating within a green cordierite cellular body of the same configuration as characterized by plot “P”, but for the case where the body is supported on a green body support member of solid disc configuration in accordance with the presently disclosed methods.

The differences in mid-core temperatures as between the two cellular bodies, and the extent to which those temperature plots deviate from the temperature of the surrounding kiln gases, are apparent from the drawing. The ring-supported green body undergoing the core temperature changes characterized by plot “P” experiences a large upward temperature excursion or thermal runaway during heating, at one point reaching a core temperature nearly 250° C. above that of the temperature of the surrounding kiln gases. On the other hand, the disc-supported green body undergoing the core temperature changes characterized by plot “I” experiences much smaller departures from the temperatures of the surrounding kiln gases during heating. Plot “I” indicates that effective control of organic binder burnout reactions, and much lower thermal stresses within the heated body, have been achieved during the debindering procedure. Large green bodies undergoing the temperature changes indicated by plot “P” will typically crack during debindering, while similarly configured bodies undergoing the changes indicated by plot “I” will not.

Embodiments of the present methods that provide wider control over related aspects of green body debindering can offer further processing advantages in specific cases. Methods wherein the cellular ceramic green bodies contain 5% or more of organic material by weight, or even 5-15% of organic material by weight are representative.

Examples of embodiments well adapted for such use include those wherein debindering is carried out in an oxygen-containing atmosphere that comprises less than 20% oxygen by volume, for example wherein debindering is carried out in an oxygen-containing atmosphere containing 13-19% oxygen by volume.

As noted above, methods wherein the circulation of the heated oxygen-containing gases past the lateral exterior surfaces of the green cellular bodies is substantially unrestricted should be used. Refractory setter plates of conventional size, e.g., providing horizontal support surfaces on the order of 1.5-2 or more times the area of the green bodies cross-sections, do not meet this need. For purposes of the present description, embodiments of the disclosed methods wherein the horizontal support surfaces of the green body support members have areas within plus or minus 20% of the areas occupied by green body cross-sections transverse to the direction of cell orientation of the bodies are effective to insure that gas circulation past the lateral exterior surfaces of the green bodies is substantially unrestricted. Embodiments wherein the horizontal support surfaces of the green body support members have areas within plus or minus 10% of the green body cross-sections provide even better gas circulation.

The kiln heating rates employed during debindering can depend in part on the size of the cellular ceramic green bodies as well as on the load of greenware within the kiln and the levels of heated oxygen-containing gas circulation that may be available. In most cases, methods wherein the step of heating the green bodies is carried out at a kiln heating rate not exceeding about 6° C./hr over a temperature range of about 200-300° C., or in some embodiments at kiln heating rates in the range of 1-4° C./hr, are suitable. Rates of gas flow past the lateral exterior surfaces of the green bodies are desirably in the range of 0.5-5 m/s, and in some cases in the range of 1-2 m/s.

The debindering of large cellular ceramic green bodies comprising cordierite precursor powders can involve a problem not encountered during the debindering of green bodies composed of other materials, in that cordierite precursor bodies typically comprise a hydrated clay constituent. The consequence of including clay in the precursor mixture is that the step of heating the green bodies then comprises both an exothermic organics burnout phase and an endothermic clay dehydroxylation phase, with the possibility of overlapping the exothermic and endothermic events producing larger internal thermal stresses than are encountered during binder burnout alone. In order to avoid problems from combined stresses, therefore, embodiments of the disclosed methods wherein the step of heating is carried out at a heating rate effective to substantially complete the binder burnout phase prior to initiating the clay dehydroxylation phase can be advantageously employed.

Apparatus such as presently used for the debindering of green cellular ceramic bodies can be adapted for use in the practice of the above disclosed methods. Such apparatus can include dedicated debindering ovens as well as large periodic or tunnel kilns that can carry out debindering and then reaction-sintering in sequential fashion.

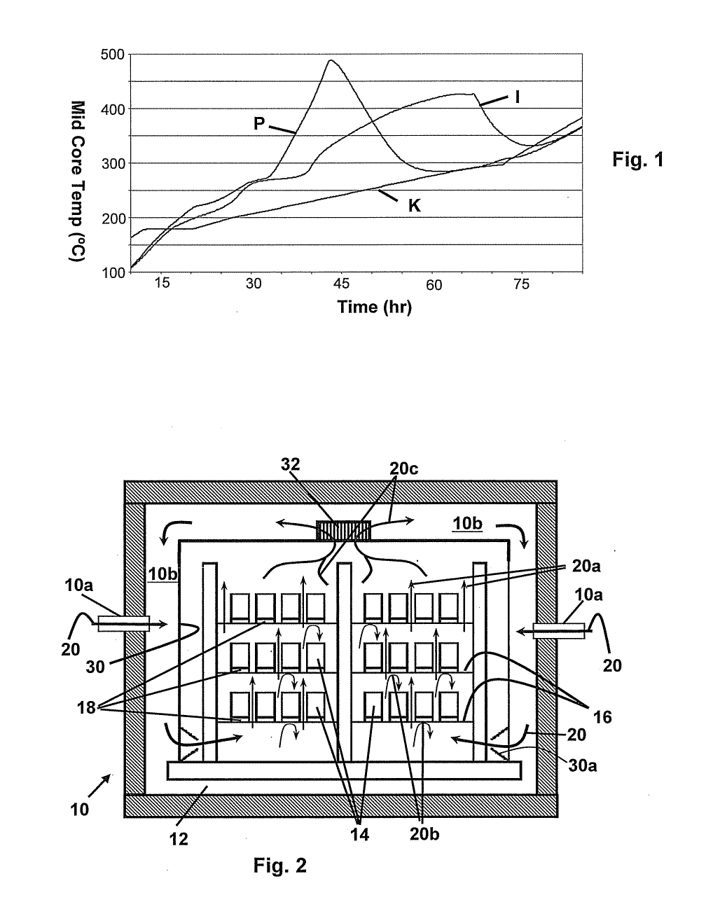

FIG. 2 of the drawings presents a schematic illustration, not in true proportion or to scale, of one embodiment of apparatus suitable for the practice of the disclosed methods. As shown in that figure, kiln 10 provides a heating enclosure 12 for heating a plurality of green bodies such as bodies 14 that are to be debindered. Also provided in the kiln are gas inlet openings 10a for delivering heated oxygen-containing gas into heating enclosure 12, as indicated by hot gas flow arrows 20.

Base supports 16 are provided within heating enclosure 12 for supporting arrays of green bodies 14 during debindering. Base supports 16 include spacings in the form of gaps or other openings in the supporting structure, described in more detail below, those spacings allowing for the unrestricted circulation of heated oxygen-containing gases through and past the base supports, as indicated by gas flow arrows 20a in the drawing.

Disposed on base supports 16 within heating enclosure 12 are flow restricting green body support members 18. Those support members are provided for the purpose of restricting the passage of heated oxygen-containing gases through cellular core portions of green bodies situated on the support members. Restricted flow is indicated by gas flow arrows 20b in the drawing, being in contrast to the substantially unrestricted flow of heated oxygen-containing gases past green bodies 14 indicated by gas flow arrows 20a.

Kiln 10 additionally includes means for circulating the heated oxygen-containing gases past the base supports, green body support members, and green bodies situated on the support members. In the embodiment of the apparatus shown in FIG. 2, those means include an internal enclosure 30 surrounding the green bodies, and a recirculation fan 32 for drawing heated oxygen-containing gas into, through, and out of that internal enclosure. In the operation of the illustrated embodiment, heated gas 20 is admitted into internal enclosure 30 through internal enclosure inlets 30a at the enclosure base, and is then drawn upwardly through the enclosure and past base supports 16, green body support members 18 and green bodies 14 by recirculation fan 32.

As indicated by gas flow arrows 20c in FIG. 2, fan 32 discharges the heated oxygen-containing gas into a recirculation duct 10b formed between the walls of kiln 10 and the walls of internal enclosure 30. Duct 10a can facilitate the recirculation of all, or of only a portion, of the heated oxygen-containing gases discharged from the top of internal enclosure 30. Hence the discharged gas may be routed back into internal enclosure 30 via inlets 30a as the control of the temperature and/or composition of the oxygen-containing gas mixture may require.

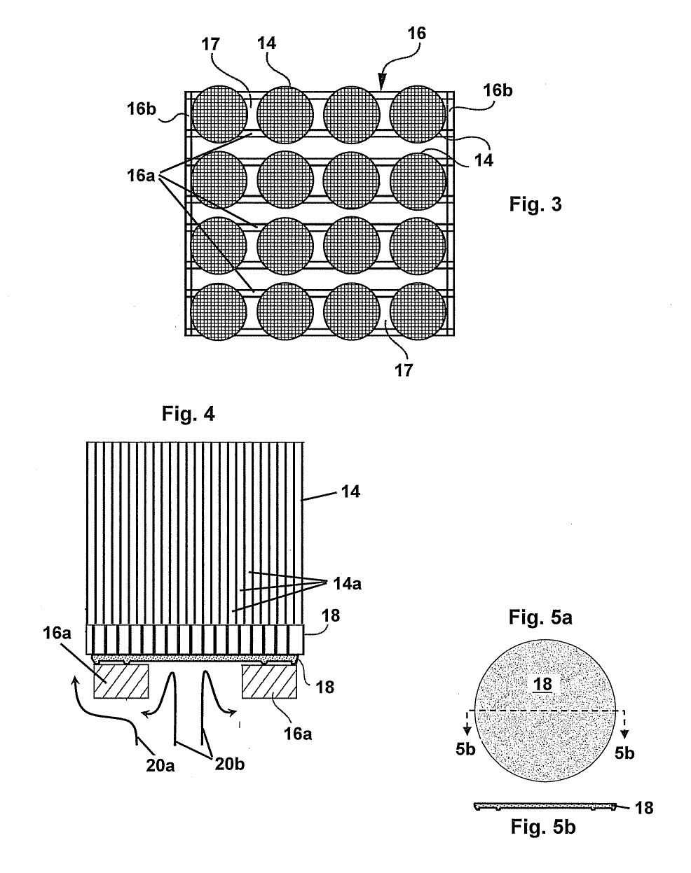

FIG. 3 of the drawings presents a schematic top plan view of an arrangement for an array of cellular ceramic green bodies 14 situated on a base support 16 for debindering in apparatus such as shown in FIG. 2. Referring more particularly to FIG. 3, underlying support for green bodies 14 is provided by a base support 16 constructed, for example, of an array of stringer beams 16a. The stringer beams are spaced apart and arranged in generally parallel relation to each other, being mounted on cross beams 16b, such as at their ends. The stringer beams 16a and cross beams 16b may be made of any suitable high temperature material for kiln furniture, such as silicon carbide. The spaces 17 between stringer beams 16a allow for the free flow of heated gases past green bodies 14 as those gases are drawn upwardly through the heated enclosure of a kiln. Base support 16 may have alternate configurations, being formed for example of perforated or slotted plates, provided only that an adequate flow of heated gases past the side surfaces of green bodies 14 is still maintained.

FIG. 4 is an enlarged side view of a green body 14 disposed on a base support of stinger beams 16a such as shown in FIG. 3, and wherein the position of a flow restricting green body support member consisting of a refractory disc setter 18 is shown. FIGS. 5a and 5b of the drawings presents top (a) and side (b) views of a green body support member 18 of disc configuration as shown in FIG. 4.

In the arrangement shown, disc 18 is positioned to block the flow of heated oxygen-containing gases into the core portion of green body 14, as indicated by gas flow arrows 20b in the drawing. The upper horizontal surface of disc 18 has an area sufficient to block heated gas flow into cells 14a of the green body while supported on that surface, but the diameter of disc 18 is sufficiently small that it does not materially restrict the circulation of heated oxygen-containing gases 20a past the exterior lateral surfaces of the green body.

The arrangement of FIG. 4 additionally includes a so-called cookie or sacrificial disk 19 of honeycomb material disposed between disc 18 and green body 14, the. use of which is conventional to protect the bottom end of green body 14 from warping and/or contamination by the material employed to construct disc 18. Such sacrificial discs alone are not designed, or intended, to materially restrict the circulation of heated oxygen-containing gas flow toward the green bodies. Disc 18 may be made, for example, of a high temperature ceramic material such as silicon carbide, alumina, mullite, zirconia, or other refractory ceramic or metal. Additionally, as in the illustrated embodiment of disc 18, the disc underside may include undercuts that beneficially minimize the contact area between disc 18 and base support stringer beams 16a.

The advantages attending the use of the above disclosed methods and apparatus are several, but among the more important from an economic viewpoint are very large reductions in crack rates, and at the same time substantial reductions in the lengths of combined debindering/firing cycles. For at least one product type, reductions in firing cycle length of 13%, together with reductions in crack rates by one order of magnitude, have been secured.

It will be apparent from the foregoing descriptions that the particular embodiments of methods and apparatus set forth above have been offered for purposes of illustration rather than limitation, and that various adaptations and modifications of those embodiments may be developed or adopted for particular purposes within the scope of the appended claims.

What is claimed is:

1. A method for debindering a cellular ceramic green body comprising a step of heating the green body in a circulating oxygen-containing atmosphere while selectively restricting circulation of the atmosphere through a cellular core section of the green body.

2. The method of claim 1 wherein selectively restricting circulation of the oxygen-containing atmosphere through the cellular core section of the green body comprises heating the green body while supporting the green body on a flow restricting horizontal support surface, the support surface having an area at least sufficient to block oxygen-containing gas flow through a majority of the cells of the green body supported on the support surface but insufficient to materially restrict the circulation of heated oxygen-containing gases past lateral exterior surfaces of the green body.

3. The method of claim 2 wherein the flow restricting horizontal support surface has an area within plus or minus 20% of the area occupied by a cross-section of the green body transverse to the direction of cell orientation of the green bodies

4. The method of claim 2 wherein circulation of the oxygen-containing atmosphere past lateral exterior surfaces of the body in a direction parallel to the direction of cell orientation of the green bodies is substantially unrestricted.

5. The method of claim 1 wherein the cellular ceramic green body contains 5% or more by weight of organic material.

6. The method of claim 1 wherein the cellular ceramic green body incorporates a hydrated clay constituent.

7. The method of claim 1 wherein the step of heating is carried out at a heating rate not exceeding about 6° C./hr over a temperature range of about 200-300° C.

8. The method of claim 7 wherein the step of heating is carried out at a heating rate in the range of 1-4° C./hr

9. The method of claim 1 wherein the oxygen-containing atmosphere includes less than 20% oxygen by volume.

10. The method of claim 9 wherein the oxygen-containing atmosphere contains 13-19% oxygen by volume.

11. The method of claim 6 wherein the step of heating comprises an organics burnout phase and a clay dehydroxylation phase.

12. The method of claim 11 wherein the step of heating is carried out at a heating rate effective to substantially complete the binder burnout phase prior to initiating the clay dehydroxylation phase.

13. Apparatus for debindering cellular ceramic green bodies comprising
a kiln having a heating enclosure for heating the bodies;
base supports disposed within the heating enclosure including spacings allowing for a free circulation of heated oxygen-containing gases past the base supports;
a plurality of flow restricting green body support members disposed on the base supports for restricting the passage of heated oxygen-containing gases through cellular core portions of green bodies situated on the support members;
kiln inlets for admitting heated oxygen-containing gases into the heating enclosure; and
means for circulating the heated oxygen-containing gases past the base supports, green body support members, and green bodies situated on the green body support members.

14. The apparatus of claim 13 wherein the green body support members comprise disc supports incorporating horizontal support surfaces, each support surface having an area at least sufficient to block oxygen-containing gas flow through a majority of the cells of a green body supported with cell openings facing the support surface, but insufficient to materially restrict the circulation of heated oxygen-containing gases past the lateral surfaces of the green body.

15. The apparatus of claim 14 wherein each of the horizontal support surfaces has an area within plus or minus 20% of the area occupied by a cross-section of the green body transverse to the direction of cell orientation in the green body.

16. The apparatus of claim 13 wherein the base supports comprise spaced refractory stringers.

17. The apparatus of claim 13 wherein the means for circulating the heated oxygen-containing gases past the base supports, green body support members, and green bodies situated on the green body support members comprise (i) an internal enclosure within the kiln and surrounding the green bodies, and (ii) a recirculation fan for drawing heated oxygen-containing gas into, through, and out of the internal enclosure.
